(19) United States
(12) Patent Application Publication
(10) Pub. No.: US 2010/0268704 A1
(43) Pub. Date: Oct. 21, 2010

(54) METHOD OF SEARCHING INFORMATION AND RANKING SEARCH RESULTS, USER TERMINAL AND INTERNET SEARCH SERVER WITH THE METHOD APPLIED THERETO

(75) Inventor: Po-Yueh Chou, Hsinchu (TW)

Correspondence Address: QUINTERO LAW OFFICE, PC, 615 Hampton Dr, Suite A202, Venice, CA, 90291, US

(73) Assignee: MITAC TECHNOLOGY CORP., Hsinchu (TW)

(21) Appl. No.: 12/424,504

(22) Filed: Apr. 15, 2009

(51) Int. Cl. G06F 17/30

(52) U.S. Cl. 707/723; 707/E17.014; 707/E17.032

(57) ABSTRACT

A search method is provided to search available information and rank search results. The method retrieves a search query and bookmark-oriented information through an internet browser or a user search engine installed on a user terminal. According to the search query, the method obtains search results from the available information. Afterwards, the search results are ranked according to the bookmark-oriented information. More specifically, the bookmark-oriented information may be used as part of the search query during searching, or used to rank the search results. Those search results that match at least part of the bookmark-oriented information are provided and ranked on the internet browser or user search engine only, or provided and ranked prior to those search results not matching any of the bookmark-oriented information, thereby providing a preferable search result closest to the user's search query.

### BACKGROUND OF THE INVENTION

1. Field of the Invention

The present invention relates to the information search operation on the internet, and more particularly, to a user terminal, an internet search server and a method applied thereon of searching information and ranking search results according to bookmark-oriented information.

2. Related Art

The fast development of the internet causes the internet users nowadays to face a critical problem of information explosion. How to find the user-required information from all the tremendous internet information has become a significant subject that the internet users, the relevant corporations and the service providers are eager to resolve. “Search engine” used on the internet is the product developed for such demands.

Based on the information search scopes, the search engines may be cataloged as the following types. One may be called “local file search engine”; which mainly builds up a file index of local files and then store the file index of information through a certain structural arrangement (or store in a database). Another may be called “remote webpage search engine”. Unlike the local files, the information searched by such search engine may be stored in various webpage servers. A program called “web crawler” is generally used to collect information from the remote webpage servers. The specific server where the remote webpage search engine locates may be considered as a centralized internet information database that stores huge quantity of internet information and allows the search engine to search for various user queries.

In FIG. 1A, internet browser 20 is a window-based browser software suites such as Internet Explorer of Microsoft Corporation, Firefox of Mozilla Foundation, Chrome of Google Corporation or Safari of Apple Inc. When the internet browser 20 is executed on the user terminal, a browsing interface 21 is provided for the user to browse internet information and submit search queries for desired internet information. Ranked search results 211 will be displayed by the internet browser 20 when a web search is requested and executed.

The conventional information search engine has at least two methods to process the webpage information collected by the web crawler. One is to build up keyword indexes. An engineer team will be assigned to perform the classification tasks of the collected internet webpage information. General website owners are also allowed to voluntarily submit their webpage information online to the engineer team. The other one performs full-text search on the collected internet information instead of cataloging indexes. So the matched information contents usually reaches hundred thousands of results for various queries. To optimize the search results, a certain algorithm will be applied to the results and rank those have higher matching degrees to prior rankings. However, the ranking service has become the most beneficial business for internet advertisements. The search result shown on the first page usually depends on the advertising ranking, not the desired information that really matches the user's need.

In U.S. Provisional Application No. 60/657,371, “Search engine that incorporates user-entered information” is disclosed to return more meaningful information in response to internet search queries. Briefly in this case, online interfaces are provided and allow the user to amend and add further descriptions for the same query, so as to reach a better search result. A method in accordance with the application comprises managing a database in response to multiple user inputs and displaying search results from the database in response to search query. The search results include a results list and supplemental data related to the search query. Managing the database includes, among other things, re-ranking elements in the results list, storing information related to relevancies of elements in the results list, blocking a link in the results list, storing links to documents related to the search query, or any combination of these. The supplemental data include descriptions of or indices to one or more concepts related to the search query. However, such search method requires the user to provide multiple descriptions and/or amend the query AFTER the first search, which is not convenient and not precise for the user.

In US Publication No. 20060074883, “Systems, methods, and interfaces for providing personalized search and information access” is disclosed. This prior art relates to systems and methods that employ “user models” to personalize generalized queries and/or search results according to information that is relevant to respective user characteristics. The “user models” can be derived from a plurality of sources including rich indexes that consider past user events, previous client interactions, search or history logs, user profiles, demographic data, and/or based upon similarities to other users (e.g., collaborative filtering). However, the chosen user-personalized information for the user model in the prior art are not precise enough and did not match the needs of advanced internet users. Besides, history information such as the user's browsing history is passive information of user behaviors collected by the browser. Such information still includes too many unwanted webpage contents, which still become noise information that should not be listed and ranked.

Although the two patented technologies propose practical methods to improve the search results, apparently they still require more complicated technologies to be realized.

### SUMMARY OF THE INVENTION

To solve the aforesaid problems of the prior art, the present invention provides a method of searching information and ranking search results through bookmark-oriented information. The presented method highly increases the accuracy of search results and effectively decreases those commercialized search results with accompanying noise information. The available information searched in the present invention includes (1) cached webpages in an internet cache database or actual webpages from the internet; and/or (2) indexed contents stored in a user terminal or any other accessible computer terminal connected to the user terminal through any type of network.

For an advanced internet user, the internet bookmarks of one or more browser are collected methodically and well organized. Such special users have clear needs to know if the desired information is located in their bookmarked webpages and the whole websites associated with their bookmarks. Visiting each bookmarked webpage/website and search one by one is too time-consuming. The present invention is proposed to fulfill such needs and resolve the generated technical problems while using bookmark information. Furthermore, such user might stored many useful webpages in his computer (user terminal). Using bookmark-oriented information to sort out the desired webpage/information stored in the user terminal is also very valuable for the advanced user. Other the other hand, what disclosed in the present invention are very useful to satisfy certain needs of an average user as well.

In an embodiment of the present invention, a method of searching and ranking available information is provided and applied to a user terminal. The method comprises the steps of: retrieving a search query from a user terminal; retrieving bookmark-oriented information that is related to at least one bookmark defined through a first internet browser installed in the user terminal; obtaining a plurality of search results according to the search query; and ranking the search results according to the bookmark-oriented information.

In a preferred embodiment, the bookmark-oriented information is retrieved by a bookmark-oriented information extractor, and the bookmark-oriented information extractor is installed as software plug-in or additional source codes compatible and incorporated with the first internet browser, a user search engine installed on the user terminal, or an internet search engine installed in an internet search server.

In a preferred embodiment, a bookmark-oriented information uploading interface is provided to upload the bookmark or the bookmark-oriented information through the first internet browser to an internet search engine.

In a preferred embodiment, at least part of the bookmark-oriented information is used as a text keyword to search within cached webpages stored in an internet cache database or within actual webpages from the internet, or to search within computer files stored in the user terminal and any computer terminal linked to the user terminal, or at least part of the bookmark-oriented information is used as an internet shortcut of a bookmarked webpage or as a file shortcut of bookmarked computer file to search for the search query therein.

In a preferred embodiment, the search results are ranked by a bookmark-oriented ranker, and the bookmark-oriented ranker is installed as software plug-in or additional source codes compatible and incorporated with the first internet browser, an internet search engine installed in an internet search server, or a user search engine installed on the user terminal.

In a preferred embodiment, the search results are ranked through a bookmark-oriented ranking algorithm that arranges and incorporates the bookmark-oriented information in an optimized way.

In a preferred embodiment, the method further comprises a step of ranking the search results according to a default ranking algorithm; the default ranking algorithm is performed by an internet search engine installed on an internet search server or by a user search engine installed in the user terminal.

In a preferred embodiment, through the internet, an internet search engine installed in an internet search server retrieving the search query from the first internet browser of the user terminal; retrieving the bookmark-oriented information through the internet search engine or the first internet browser; the internet search engine obtaining the search results from cached webpages stored in an internet cache database; and the internet search engine ranking the search results according to the bookmark-oriented information.

In a preferred embodiment, an internet search engine of an internet search server retrieving the search query from the first internet browser; the first internet browser retrieving the bookmark-oriented information; the internet search engine obtaining the search results from cached webpages stored in an internet cache database according to the search query, and returning the search results to the first internet browser through the internet; and the first internet browser ranking the search results according to the bookmark-oriented information.

In a preferred embodiment, the first internet browser retrieving the bookmark-oriented information; an internet search engine of an internet search server retrieving the search query from the first internet browser, and obtaining a plurality of internet search results from cached webpages stored in an internet cache database according to the search query, and returning the internet search results to the first internet browser through the internet; a user search engine installed in the user terminal obtaining a plurality of local search results from indexed contents stored on the user terminal or any computer terminal connected to the user terminal through any network, and returning the local search results to the first internet browser; and the first internet browser ranking the internet search results and the local search results according to the bookmark-oriented information.

In a preferred embodiment, a user search engine installed in the user terminal retrieving the bookmark-oriented information; the user search engine obtaining a plurality of local search results from indexed contents stored on the user terminal or any computer terminal connected to the user terminal through any network; and the user search engine ranking the local search results according to the bookmark-oriented information.

In a preferred embodiment, only bookmark-oriented search results are provide and ranked according to the bookmark-oriented information, and each of the bookmark-oriented search results indicates an indexed content or a webpage matching the search query and also at least a part of the bookmark-oriented information.

In a preferred embodiment, according to the bookmark-oriented information, bookmark-oriented search results are ranked prior to non-bookmark-oriented search results, wherein the bookmark-oriented search results indicates an indexed content or a webpage matching the search query and also at least a part of the bookmark-oriented information, and each of the non-bookmark-oriented search result indicates another indexed content or webpage matching the search query but failing to match any of the bookmark-oriented information.

In a preferred embodiment, each of the search results comprises at least a brief and at least a link for part or any incorporation of at least one cached webpage stored in an internet cache database, actual webpage from the internet, indexed content stored in the user terminal or any other accessible computer terminal connected to the user terminal through any type of network

In a preferred embodiment, the bookmark-oriented information comprises at least part, any one or any incorporation of web address or file address, type, description, location, size, date information including setup date, access date, edit date and last review date, folder-related information, and user-defined bookmark-ranking information related to the bookmark.

In a preferred embodiment, the bookmark comprises a computer-accessible internet shortcut that directs to a certain web address of a specific webpage, and/or a file shortcut addressing a specific computer file stored in the user terminal or any computer terminal connected to the user terminal through any network.

In a preferred embodiment, the bookmark is selected from one or any incorporation of the group consisting of a terminal bookmark stored in the user terminal or any other computer terminal connected to the user terminal through any type of network, an online bookmark stored on an remote web server, an exported bookmark listed within an exported bookmarking webpage and a second bookmark defined through a second internet browser.

In another embodiment of the present invention, a user terminal of searching and ranking available information is proposed. The user terminal comprises: a first internet browser installed in the user terminal; and at least one bookmark defined through the first internet browser; wherein the user terminal is adapted such that the first internet browser retrieves bookmark-oriented information related to the bookmark; wherein the user terminal is adapted such that the first internet browser, if receives a plurality of search results according to a search query, ranks the search results according to the bookmark-oriented information.

In another embodiment of the present invention, a internet search server of searching and ranking available information is proposed. The internet search server is connected to the internet and an internet cache database; and through the internet, the internet search server receives a search query submitted from a first internet browser installed in a user terminal. The internet search server comprises: an internet search engine, installed in the internet search server and according to the search query, retrieving a plurality of search results from cached webpages stored in the internet cache database; wherein the internet search server is adapted such that through the internet and the first internet browser, the internet search engine receives bookmark-oriented information related to a bookmark defined through the first internet browser; wherein the internet search server is adapted such that the internet search engine, if receives the bookmark-oriented information and the search results, ranks the search results according to the bookmark-oriented information and then returns the ranked search results to the first internet browser.

The present invention mainly provides a “bookmark-oriented” method of searching and ranking internet information. The proposed method in the present invention may be performed by at least an internet browser or a user search engine on the user terminal and/or the internet search engine on the internet search server. One or more plug-in software kit that is corresponding to and compatible with the internet browser, the user search engine or the internet search engine may include/initiate some or all the procedures involved in the method.

These and other features, aspects, and advantages of the present invention will become better understood with reference to the following description and appended claims. It is to be understood that both the foregoing general description and the following detailed description are examples, and are intended to provide further explanation of the invention as claimed.

### BRIEF DESCRIPTION OF THE DRAWINGS

The present invention will become more fully understood from the detailed description given herein below for illustration only, and thus is not limitative of the present invention, and wherein:

FIG. 1 is an explanatory diagram illustrating a browser interface of an internet browser in the prior art;

FIG. 2A is a block diagram of a system architecture that allows the method of the present invention to be performed thereon;

FIG. 2B is an explanatory diagram illustrating a bookmark editing interface of the internet browser in the present invention.

FIG. 3A is an major operation flow chart, which illustrates a method of searching information and ranking search results according to the present invention;

FIG. 3B is an explanatory diagram which illustrates an example of extracting bookmark-oriented information;

FIG. 4A is a block diagram of another system architecture that allows the method of an embodiment in the present invention to be performed thereon;

FIG. 4B is an explanatory diagram illustrating the operations performed in the method of the embodiment in FIG. 4A;

FIG. 4C is a block diagram of another system architecture that allows the method of FIG. 4B be performed thereon;

FIG. 4D is an explanatory diagram illustrating a browser interface of the internet browser in the present invention;

FIG. 4E is an explanatory diagram illustrating the ranking results displayed in the browser interface of the internet browser in the present invention;

FIG. 4F is another explanatory diagram illustrating another ranking results displayed in the browser interface of the internet browser in the present invention;

FIG. 5A is a block diagram of another system architecture that allows the method of another embodiment in the present invention to be performed thereon;

FIG. 5B is an explanatory diagram illustrating the operations performed in the method of the embodiment in FIG. 5A;

FIG. 6A is a block diagram of another system architecture that allows the method of another embodiment in the present invention to be performed thereon;

FIG. 6B is a block diagram of another system architecture that allows the method of another embodiment in the present invention to be performed thereon;

FIG. 6C is an explanatory diagram illustrating the operations performed in the method of the embodiment in FIG. 6B;

### DETAILED DESCRIPTION OF THE INVENTION

Reference will now be made in detail to the present preferred embodiments of the invention, examples of which are illustrated in the accompanying drawings. Wherever possible, the same reference numbers are used in the drawings and the description refers to the same or the like parts.

The available information for search in the present invention includes (1) cached webpages in an internet cache database or actual webpages from the internet; and/or (2) indexed contents stored in a user terminal or any other accessible computer terminal connected to the user terminal through any type of network.

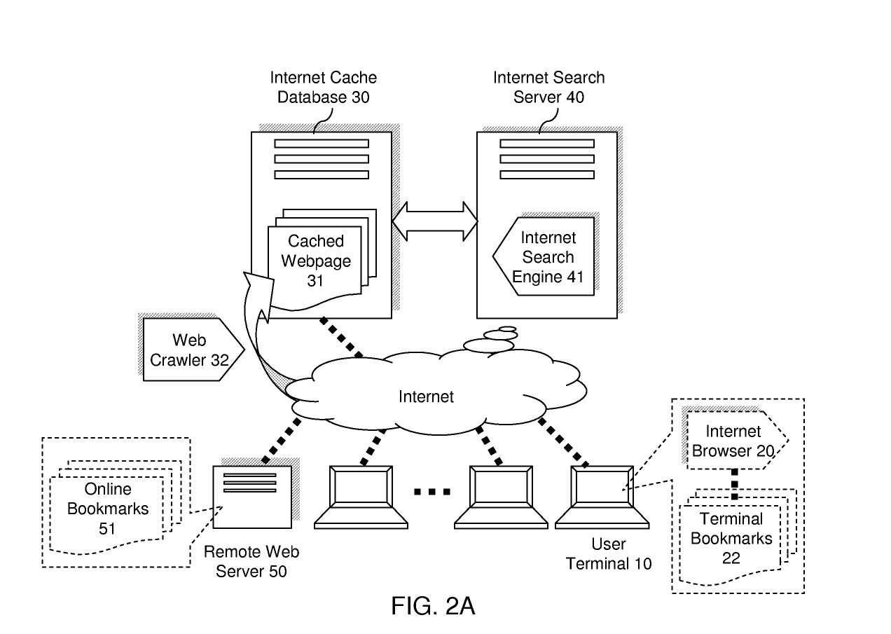

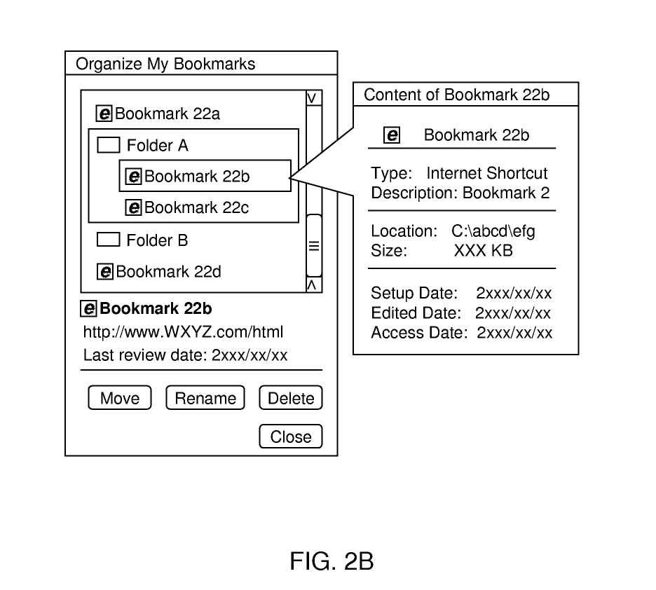

First of all, please refer to FIG. 2A, which illustrates a system architecture that allows the method of the present invention to be performed thereon.

Internet cache database 30 is a mass storage linked to the internet. A web crawler 32, operating as an internet information collector, gathers cached webpages through the internet and stores in the internet cache database 30.

Internet search server 40 is linked to the internet cache database 30 and the internet. A internet search engine 41 installed and operating in internet search server 40 receives plenty of searching requests submitted from user terminal 10, searches out the matched webpage contents from the internet cache database 30, and returns “search results” (ranked, listed, matched webpage contents) to the internet browser 20 of the user terminal 10.

User terminal 10 is generally an internet device that is capable of connecting to the internet and providing service of internet browsing, which includes but not is limited to Mobile Internet Device (MID), Personal Computer (PC), smart phone and etc. The user terminal 10 has certain hardware components (such as processor, memory, chipset, input device, output device like display . . . and etc.) and essential software/firmware programs (OS/Operating System, BIOS/Basic Input/Output System, drivers and application programs . . . and etc.) configured thereon to perform internet connecting and browsing function.

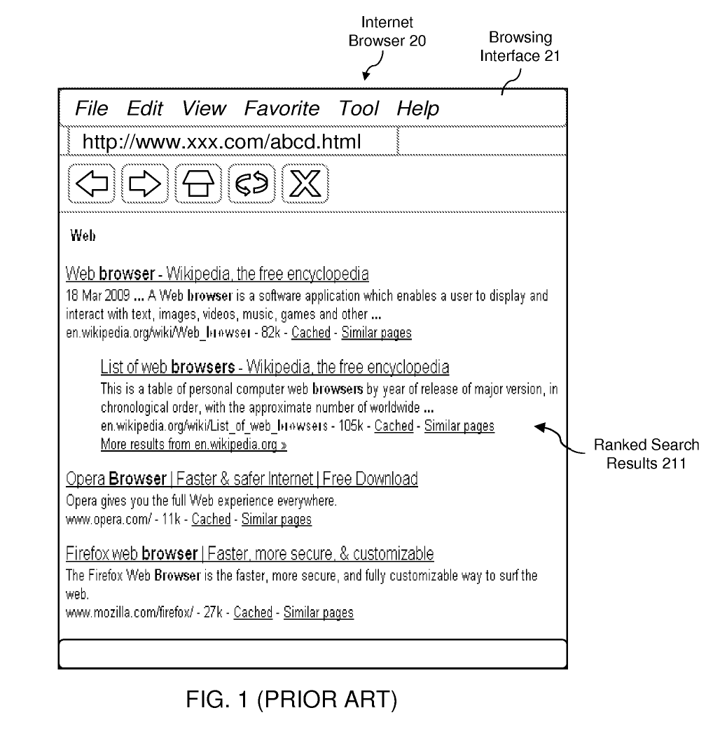

Internet browser 20 is an internet browsing software program that is installed and operative on the user terminal 10. Generally, the internet browser 20 may include but not limit to the window-based browser software suites such as Internet Explorer of Microsoft Corporation, Firefox of Mozilla Foundation, Chrome of Google Corporation or Safari of Apple Inc. As shown in FIG. 1A, the internet browser 20, when executed on the user terminal 10, provides a browsing interface 21 for the user to interactively operate the internet browser 20 and browse internet information. The browsing interface 21 may be a window based interface, interactive graphic interface or any other human-machine interface.

To record specific webpages, the internet browser 20 allows the user to set up bookmarks 22 and store the bookmarks 22 in computer-accessible recording media (such as memory and/or hard disk) of the user terminal 10 (or a user-controllable remote terminal linked with the user terminal 10 through any type of network). A user-defined bookmark in the present invention includes a user-organized, computer-accessible “internet shortcut” that directs to a certain web address (i.e. URL/Uniform Resource Locator) of a specific webpage; the user-defined bookmark in the present invention may also include a “file shortcut” addressing a specific computer file stored in a user terminal or any computer terminal connected to the user terminal through any network. The bookmark allows a user to easily catalog and access web pages that the user “has visited” and “chosen to save”. In FIG. 2B. The bookmark 22b records its web address or file address, type, description, location, size, and date information including setup date, access date, edit date, and last review date. Other information of the bookmark 22b such as the belonging folder A (where the bookmark 22b belongs thereto), the ranking of the bookmark 22b and other bookmark 22c within the belonging folder A and, the ranking of said belonging folder A among all other folder B and bookmarks 22a/22d at the same level, all referred as “folder-related information”, are also available. Such ranking information regarding to the bookmarks and the bookmark folders are defined as “user-defined bookmark-ranking information”. All the information related to at least one user-defined bookmark mentioned in this paragraph is deemed as “bookmark-oriented information” for searching and ranking the internet information.

A user-defined bookmark may also be created and stored as “online bookmarks” by adding, importing bookmarks from the user terminal 10 to a certain webpage of internet service provider, such as Google Bookmarks. With the advent of “social bookmarking”, shared bookmarks online have become a means for users sharing similar interests to pool web resources, or to store their bookmarks in such a way that they are not tied to one specific computer or browser. In FIG. 2A, web-based bookmarking services let users save online bookmarks 51 on a remote web server 50, retrievable through the internet, accessible from anywhere.

In most of situations, the bookmarks or the bookmark-related information may be found in a certain folder. For example, Internet Explorer stores its bookmarks and bookmarking folders in the following folder:

C:\Documents and Settings\username\Favorites

However, the internet browser 20 also allows the user to export the bookmarks and stored at any location as a *.html webpage named “bookmarks.html”. Internet Explorer and Firefox all provide the function to export the user-defined bookmarks as *.html format. Firefox also allows to backup the bookmarks in “*,json” format. Such “Exported bookmarking webpage” is a browser-openable webpage file (such as *.html file) with the exported bookmarks and the exported bookmarking folders listed therein as its whole content. Here an exported bookmark will be listed within the exported bookmarking webpage.

Furthermore, if at least one second internet browser (not shown; no matter where it installed) is available, the second internet browser may possibly share the same sets of the bookmarks of the internet browser 20 or import the bookmarks of the internet browser 20 directly; or the second internet browser may have its dedicated second bookmarks (not shown; no matter where it is stored).

Hence, the bookmark hereinafter will basically include at least (1) the “terminal bookmark” (such as bookmarks 22 in FIG. 2A) stored in the user terminal (or the user-controllable remote terminal, or any other computer terminal connected to the user terminal through any network); (2) the “online bookmark” stored on the remote web server; (3) the “exported bookmark” listed within the exported bookmarking webpage (stored in the user terminal or any computer terminal connected thereto via any network); and/or (4) at least one second bookmark defined through a second internet browser.

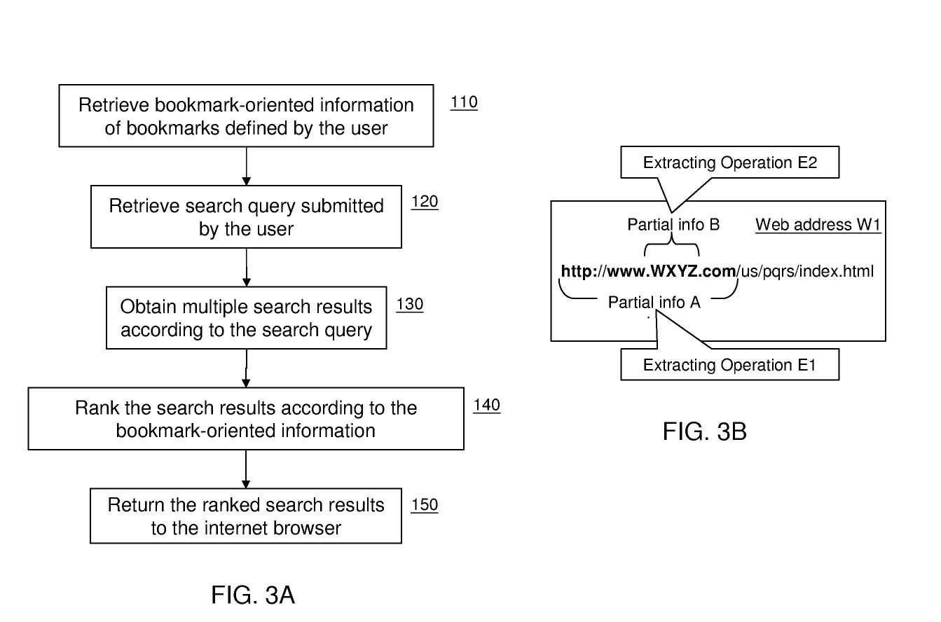

FIG. 3A is an major operation flow chart, which illustrates a method of searching and ranking internet information according to the present invention;

Step 110: Retrieve bookmark-oriented information of bookmarks defined by the user.

The bookmarks include at least one or any incorporation of the terminal bookmarks, the online bookmarks, the exported bookmarks and the second bookmarks disclosed above. The bookmark-oriented information includes partial or complete information retrieved from one or any incorporation of web address, type, description, location, size, and date information including setup date, access date, edit date, last review date, review times and other user-defined bookmark-related information. An example about retrieving partial information of the bookmark-oriented information is as shown in FIG. 3B. If the web address W1 is recorded in a bookmark, then Step 110 may include extracting partial information of the web address W1; namely, (1) extract partial information A “http://www.WXYZ.com/” during extracting operation E1 and (2) extract partial information B “WXYZ” during extracting operation E2.

Step 120: Retrieve search query submitted by the user.

A search query is conditions that the user submits for web search. The user may submit the search query from the user terminal 10 in FIG. 1. The search query may include the conditions such as keyword(s) and keyword location, language(s), authority, geographic location(s) of webpages/websites, algorithm(s) (such as Boolean operation “and”, “or”, “not”), and etc. Furthermore, the retrieved bookmark-oriented information may optionally be used as a search query. For example, these partial bookmark-oriented information A “http://www.WXYZ.com/” and B “WXYZ” in FIG. 3B may be used as: (1) text keywords to search text contents within webpages (cached webpages in the internet cache database or actual webpages from internet) or within computer files (stored in the user terminal and any linked computer terminal); or (2) as shortcuts of bookmarked webpages (internet shortcuts like USLs or web addresses), or as shortcuts of bookmarked computer files (file shortcut) to search for the search query therein.

Step 130: Obtain multiple search results according to the search query. A search result includes a brief of a certain cached webpage and link(s) to the cached webpage in the internet cache server 30 and/or the actual webpage on the internet. The search query is applied by the internet search engine 41 to search the internet information directly from the internet or indirectly from the cached webpages stored in the internet cache database 30. Multiple search results will be obtained by the internet search engine 41.

Step 140: Rank the search results according to the bookmark-oriented information such that those bookmark-oriented search results are ranked in a higher priority.

The internet search engine 41 generally already has a default ranking operation to rank the search results. The default ranking operation ranks the search results through a default ranking algorithm; such default ranking algorithm is defined by the service providers (such as Google) of web search and automatically performed by the internet search engine 41, and is changeable by the user. The default ranking algorithm will base on the search query to rank the search results. Generally the default ranking operation is executed by the internet search engine 41 and completed on the internet search server 40. To avoid noise information and increase the accuracy of the ranked search results, the present invention utilizes the bookmark-oriented information to perform a bookmark-oriented ranking operation. Either the internet search engine 41 or the internet browser 20 on the user terminal 10, before or after the search results are ranked by the default ranking operation, will rank the search results according to the bookmark-oriented information, namely performing the bookmark-oriented ranking operation. In other words, the internet search engine 41 may execute both the default ranking operation and the bookmark-oriented ranking operation on the internet search server 40; and the internet browser 20, if incorporated with a bookmark-ranking plug-in that supports the function of ranking the search results according to the bookmark-oriented information, can execute the bookmark-oriented ranking operation on the user terminal 10. A plug-in, also known as “add-on”, is a software extension that supports specific function(s) on demand.

Step 150: Return the ranked search results to the internet browser.

The following sections include several embodiments to describe the searching and ranking operations in details.

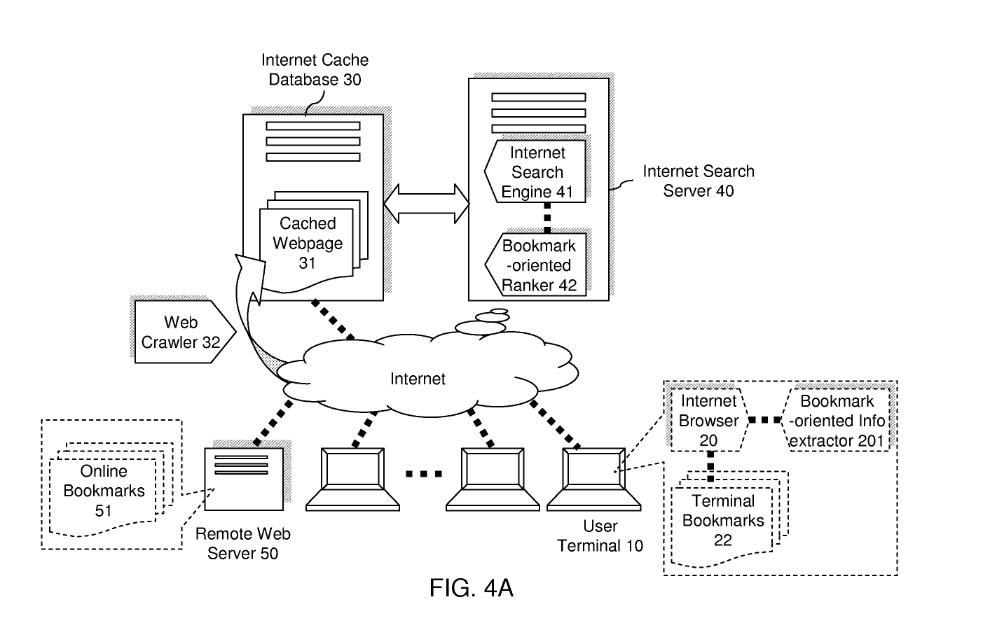

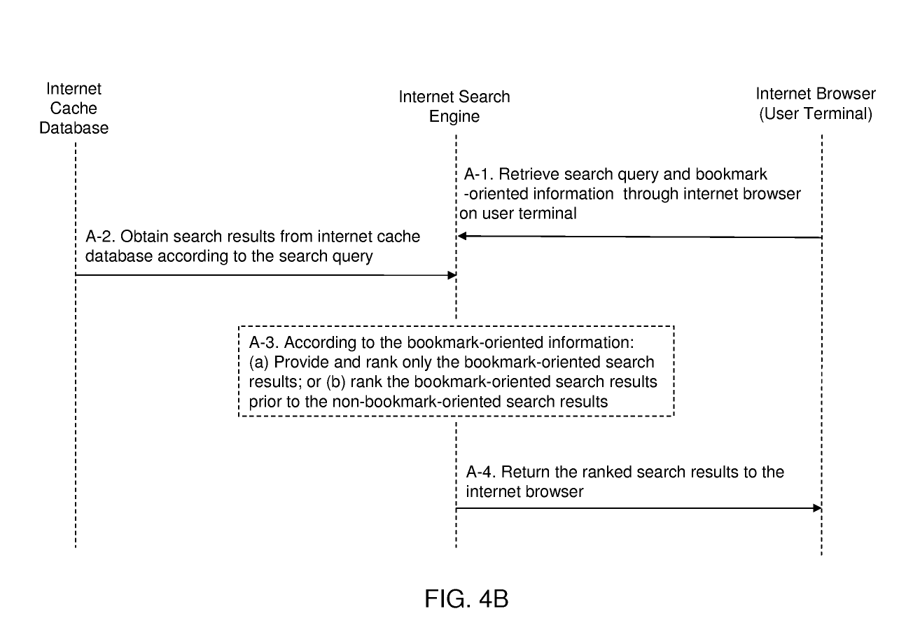

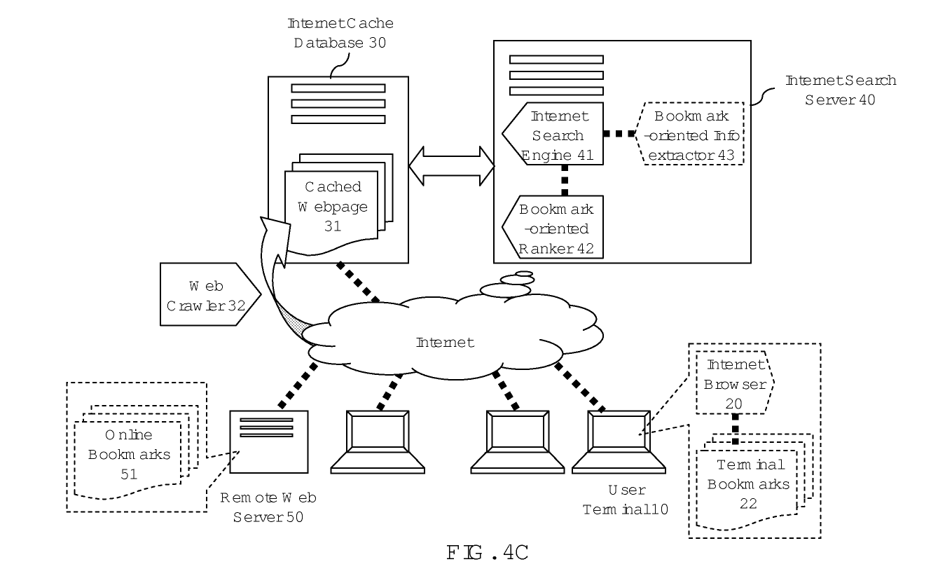

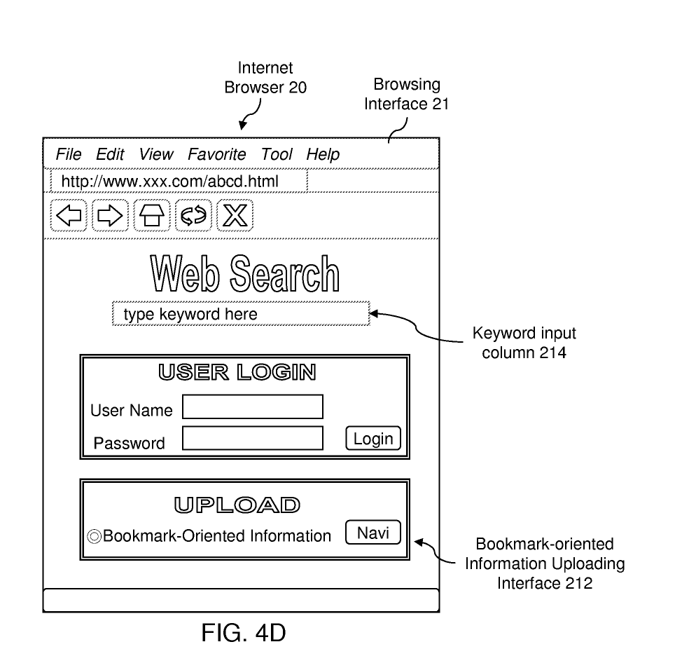

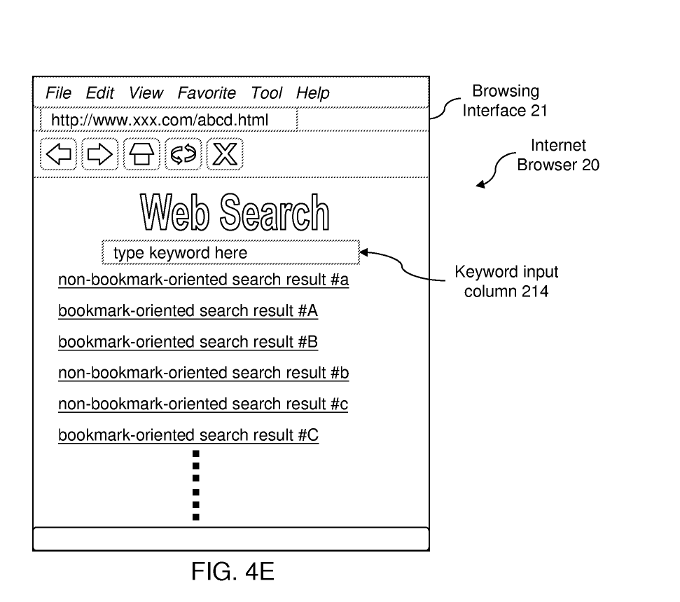

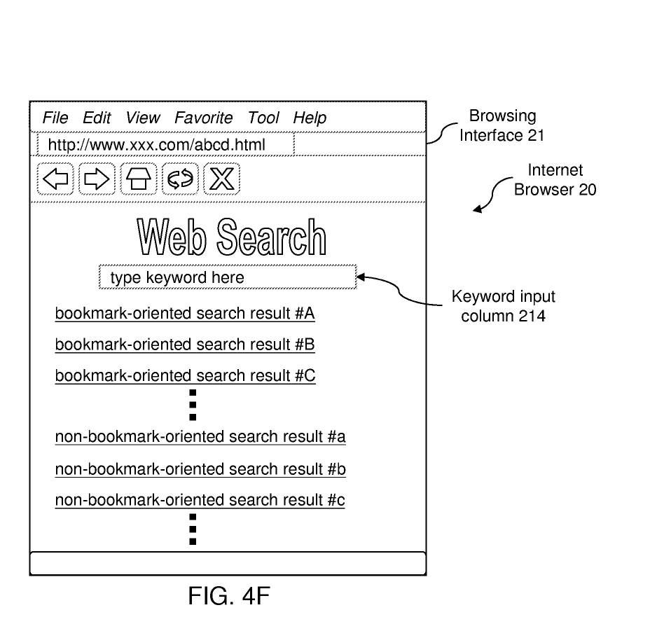

Please refer to FIG. 4A, which is another system architecture that allows the method of an embodiment in the present invention to be performed thereon.

Most of the elements in FIG. 4A are the same as in FIG. 2A. Only the differences of FIG. 4A are described in this section. In FIG. 4A, a bookmark-oriented ranker 42 is installed in the internet search server 40. The bookmark-oriented ranker 42 is a software plug-in or additional source codes compatible and incorporated with the internet search engine 41. The bookmark-oriented ranker 42 mainly executes the bookmark-oriented ranking operation; namely, the bookmark-oriented ranker 42 ranks the search results according to the bookmark-oriented information while the search results are obtained by the internet search engine 41.

Another difference is that a bookmark-oriented information extractor 201 is installed in the user terminal 10. The bookmark-oriented information extractor 201 is a software plug-in or additional source codes compatible and incorporated with the internet browser 20. The bookmark-oriented information extractor 201 mainly extracts the bookmark-oriented information from the bookmarks defined in the former sections above. The bookmark-oriented information may be extracted prior to a web search operation if the bookmark-oriented information extractor 201 is enabled in advance.

Refer to FIG. 4B, which is an explanatory diagram illustrating the operations performed in the method of the embodiment in FIG. 4A.

Operation A-1: Retrieve the search query and the bookmark-oriented information through the internet browser on the user terminal. The internet browser 20 of the user terminal 10 provides a browser interface for the user to submit his search query. Generally, a keyword input column 214 is provided on the browser interface 21, as shown in FIG. 4D. Certainly, any other search conditions may be provided as well for user selection.

If the bookmark-oriented information extractor 201 is enabled in advance, the bookmark-oriented information may be extracted prior to a web search operation and ready to be retrieved in Operation A-1. Such ways facilitates an automatic process to upload the bookmark-oriented information for every time performing a web search operation.

Please refer to FIG. 4C, which is another system architecture that allows the method of the present embodiment be performed thereon. If the upload is automatically executed, the user terminal 10 may not need the bookmark-oriented information extractor 201. Instead, a bookmark-oriented information extractor 43 maybe installed in the internet search server 40. The bookmark-oriented information extractor 43 is also a software plug-in or additional source codes compatible and incorporated with the internet search engine 41. The bookmark-oriented information extractor 43 may automatically or passively gather the bookmark-oriented information whenever the user terminal 10 is connected to the internet.

When a web search operation is performed, a bookmark-oriented information uploading interface 212 (see FIG. 4D) may be provided by the bookmark-oriented information extractor 43 for the user to upload the bookmarks manually. The uploaded bookmarks will be further processed by the bookmark-oriented information extractor 43 to extract the bookmark-oriented information. The bookmark-oriented information uploading interface 212 may be provided to upload the bookmark-oriented information directly. Through the means disclosed in FIG. 4C and FIG. 4D, the search query and the bookmark-oriented information may be retrieved as well as those shown in FIG. 4A.

Referring back to FIG. 4B again, Operation A-2 shows: obtain search results from internet cache database according to the search query. A search result includes a brief of a certain cached webpage and link(s) to the cached webpage in the internet cache server 30 and/or the actual webpage on the internet.

Operation A-2 may be performed with or without the bookmark-oriented information used as at least a part of the search query. If Operation A-2 is performed “with” the bookmark-oriented information used as part of the search query, only bookmark-oriented search results are retrieved. A bookmark-oriented search result is a search result that indicates a webpage matching the search query and also a part of the bookmark-oriented information or the whole bookmark-oriented information. If Operation A-2 is performed “without” the bookmark-oriented information used as part of the search query, both the bookmark-oriented search results and those non-bookmark-oriented search results are retrieved. The non-bookmark-oriented search result is a search result that indicates a webpage matching the search query but failing to match any of the bookmark-oriented information.

In Operation A-3: (a) if Operation A-2 is performed WITH the bookmark-oriented information used as at least part of the search query, only the bookmark-oriented search results is provided and ranked according to the bookmark-oriented information: (b) if Operation A-2 is performed WITHOUT the bookmark-oriented information used as at least part of the search query, the bookmark-oriented search results are ranked according to the bookmark-oriented information and ranked prior to the non-bookmark-oriented search results. Operation A-3(a) and (b) both execute the operation of ranking the search results according the bookmark-oriented information.

Furthermore, the bookmark-oriented search results may be ranked through a bookmark-oriented ranking algorithm that arranges and incorporates the bookmark-oriented information in an optimized way. Certainly, a default ranking algorithm may be also used to rank the search results. FIG. 4E shows a list of the search results ranked through the default ranking algorithm with the bookmark-oriented search results and those non-bookmark-oriented search results mixed up together. Referring to FIG. 4F, if the bookmark-oriented ranking algorithm is applied to the search resulted listed in FIG. 4E, the bookmark-oriented search results may be sorted our and ranked prior to the non-bookmark-oriented search results. Meanwhile, the bookmark-oriented search results #A, #B, #C may optionally (1) keep the same ranking as ranked by the default ranking algorithm, as shown in FIG. 4F; or (2) change the ranking according to any other algorithm (such as the bookmark-oriented ranking algorithm) instead of the default ranking algorithm.

Although Operation A-3(a) or (b) might be designed for more satisfying the needs of an advanced user. Bookmark still can be a very good user-behavior index that achieves optimized, personalized search results for different average users. For example, if an integration algorithm is defined to incorporate the bookmark-oriented ranking algorithm and the default ranking algorithm, it is possible to provide a mixed-up bookmark-oriented/non-bookmark-oriented search results based on the calculations and weightings of both bookmark-oriented factors (such as those used in the bookmark-oriented ranking algorithm) and non-bookmark-oriented factors (namely those used in the default ranking algorithm).

Operation A-4: Return the ranked search results to the internet browser.

For the operations described through FIGS. 4A˜4F, if the bookmark-oriented information is pre-retrieved and stored available for instant access of the internet search engine 41 before a web search is submitted, the response time or the total search time of the web search will be relatively shorter.

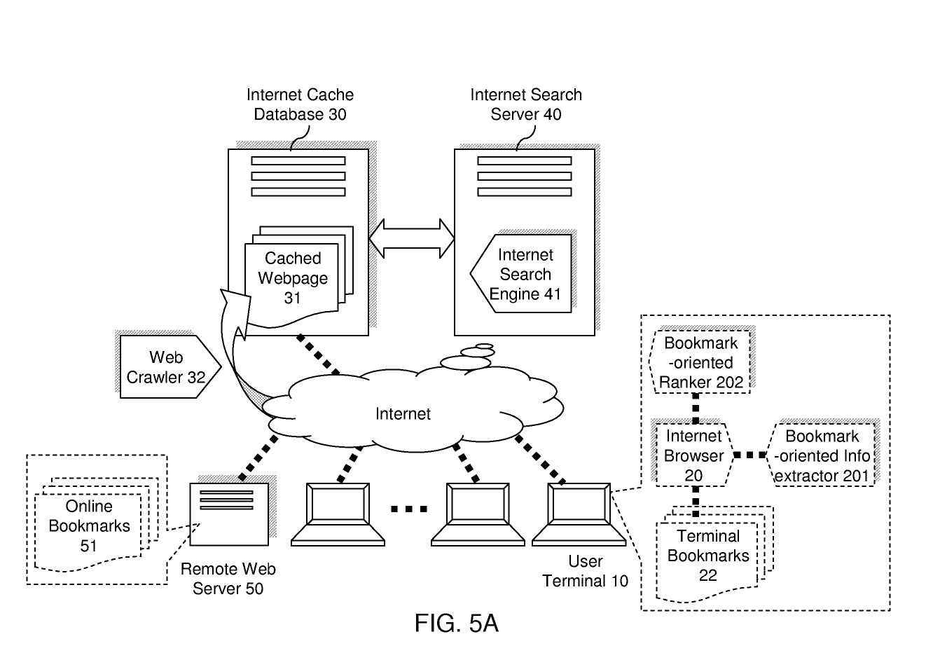

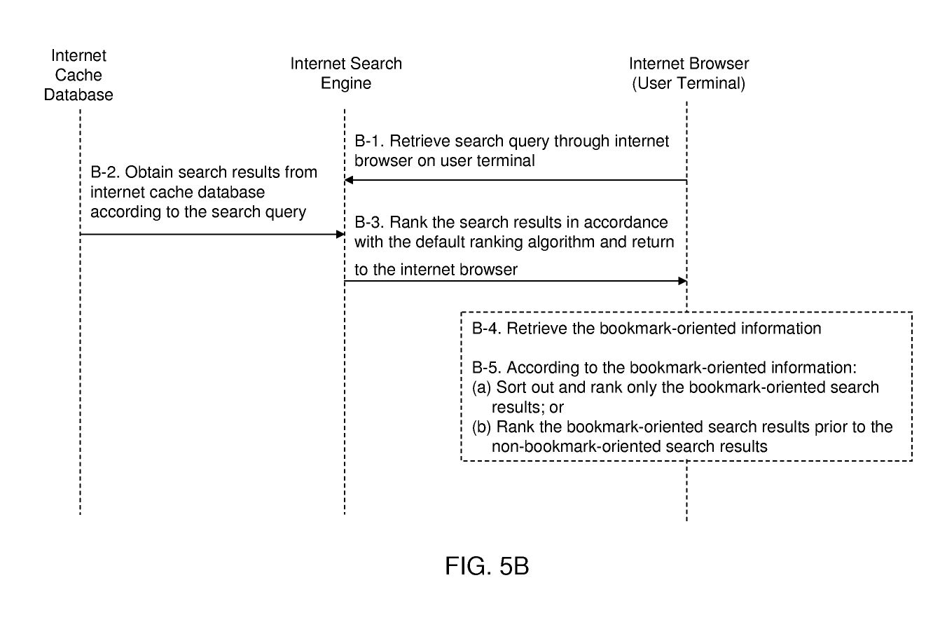

Please refer to FIG. 5A, which is another system architecture that allows the method of an embodiment in the present invention to be performed thereon.

Most of the elements in FIG. 5A are the same as in FIG. 4C. The basic difference of FIG. 5A is both a bookmark-oriented Information extractor 201 and a bookmark-oriented ranker 202 are installed in the user terminal 10. Each of the bookmark-oriented Information extractor 201 and the bookmark-oriented ranker 202 are software plug-ins or additional source codes compatible and incorporated with the internet browser 20. The bookmark-oriented Information extractor 201 and the bookmark-oriented ranker 202 have the same definitions as in the sections mentioned above. Namely, all the operations of retrieving the bookmark-oriented information and ranking the search results are executed on the internet browser 21. An integrated software plug-in or additional source code package may be provided to incorporate the functions of both the bookmark-oriented Information extractor 201 and the bookmark-oriented ranker 202.

Refer to FIG. 5B, which is an explanatory diagram illustrating the operations performed in the method of the embodiment in FIG. 5A.

Operation B-1: Retrieve the search query through the internet browser on the user terminal. Since the bookmark-oriented information is now collected by the internet browser 20, the bookmark-oriented information no longer needs to be uploaded to the internet search engine 41 of the internet search server 40. Here only the search query is sent from the internet browser 20 to the internet search engine 41.

Operation B-2: Obtain search results from internet cache database according to the search query. Since now the bookmark-oriented information no longer needs to be uploaded to the internet search engine 41, the search query will be used directly to obtain the search results from the cached webpages 31 of the internet cache database 30.

Operation B-3: Rank the search results in accordance with the default ranking algorithm and return to the internet browser. Since now the bookmark-oriented information is not used by the internet search engine 41 to sort out and/or rank the bookmark-oriented search results, the raw search results are only ranked through the default ranking algorithm of the internet search engine 41 and all of the such-ranked search results will be returned to the internet browser 20.

Operation B-4. Retrieve the bookmark-oriented information. If the bookmark-oriented information extractor 201 installed in the user terminal 10 is enabled in advance, the bookmark-oriented information may be extracted and stored prior to a web search operation and ready to be retrieved in Operation B-4. Such ways facilitates an automatic process to upload the bookmark-oriented information for every time performing a web search operation.

Operation B-5. According to the bookmark-oriented information: (a) Sort out and rank only the bookmark-oriented search results; or (b) Rank the bookmark-oriented search results prior to the non-bookmark-oriented search results. Operation B-5(a) and (b) both execute the operation of ranking according the bookmark-oriented information; only the details are different.

In Operation B-5(a), similar to Operation A-3(a) of FIG. 4B, based on the bookmark-oriented information, the bookmark-oriented search results are sorted out first. And then only the sorted-out bookmark-oriented search results are ranked according to the bookmark-oriented information, namely through the bookmark-oriented ranking algorithm.

Operation B-5(b) is similar to Operation B-5(a) and Operation B-5(a) of FIG. 5B and Operation A-3(b) of FIG. 4B. However, in Operation B-5(b), the bookmark-oriented search results are sorted out and ranked prior to the non-bookmark-oriented search results. That means both the bookmark-oriented search results and the non-bookmark-oriented search results will be listed on the browser interface of the internet browser 20. If an integration algorithm is defined to incorporate the bookmark-oriented ranking algorithm and the default ranking algorithm, it is possible to provide a mixed-up bookmark-oriented/non-bookmark-oriented search results based on the calculations and weightings of both bookmark-oriented factors and non-bookmark-oriented factors.

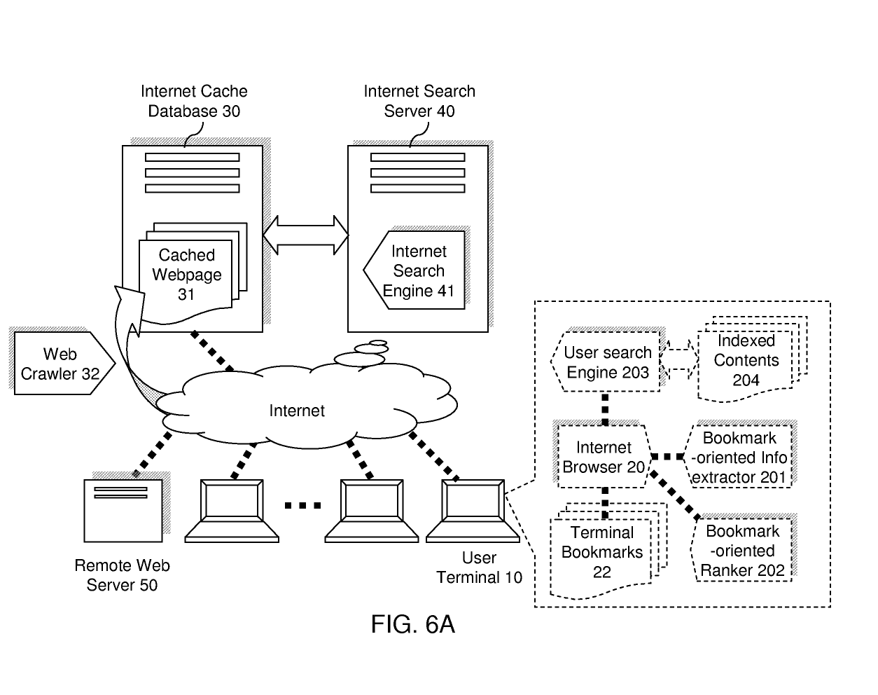

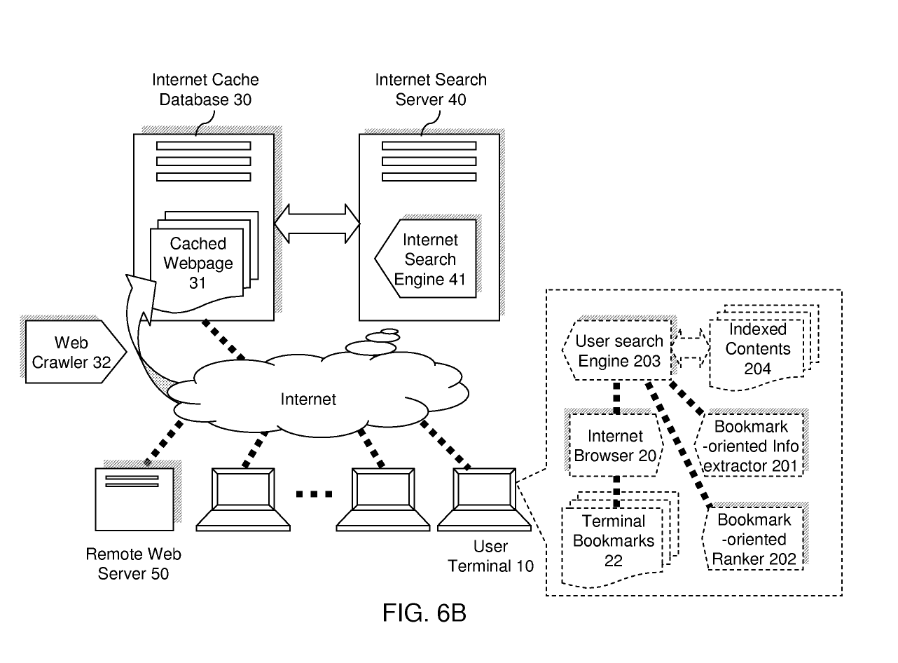

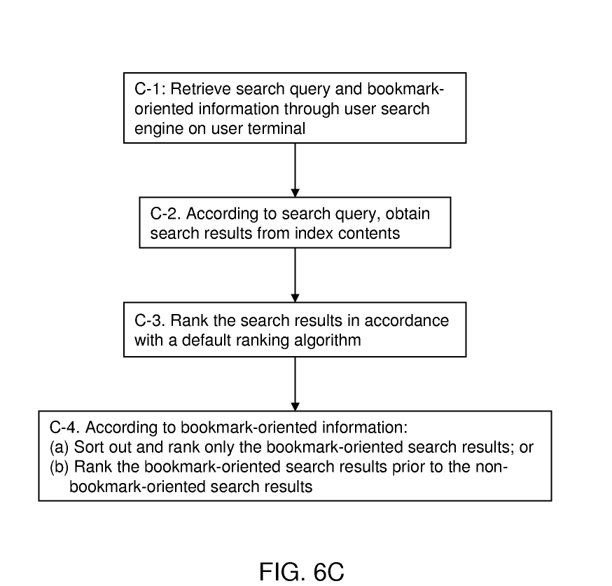

Please refer to FIG. 6A, which is another system architecture that allows the method of an embodiment in the present invention to be performed thereon.

Most of the elements in FIG. 6A are the same as in FIG. 5A. The basic difference of FIG. 6A is a user search engine 203 is installed in the user terminal 10. The user search engine 203 is known as “desktop search software” installed on the user terminal 10 and compatible with the internet browser 10. An example for the user search engine 203 is Google Desktop. Google Desktop is desktop search software made by Google for Mac OS X, Linux, and Microsoft Windows. The program allows text searches of a user's e-mails, computer files, music, photos and chats stored on the user terminal 10 (or on any accessible terminals connected with the user terminal 10 via any type of network), as well as webpages viewed/stored, and other “Google Gadgets.” The user search engine 203 performs an indexing of all the files in the user terminal 10. The indexing may be executed from time to time as needed. After performing searches, search results can also be returned to by displayed the Internet browser 20 of the user terminal 10. The files and webpages indexed by the user search engine 203 are defined here as indexed contents 204, which are stored in the user terminal 10 and may be instantly accessed by the user search engine 203 while a search query is submitted. Meanwhile, the user search engine 203 may also provide an index browser interface (not shown but may be similar to the browser interface of the internet browser 20) to browse the indexed contents 204, or only to listed the search results of the indexed contents 204.

Besides, in FIG. 6A, the bookmark-oriented Information extractor 201 and the bookmark-oriented ranker 202 are installed as software plug-ins or additional source codes compatible and incorporated with the internet browser 20. The bookmark-oriented Information extractor 201 and the bookmark-oriented ranker 202 have the same definitions as in the sections mentioned above. The search results defined in the present invention may not only include those from the cached webpages 31 of the internet cache server 30, but also those from the indexed contents 204 which are indexed by the user search engine 203. Namely, part of the search results may be retrieved from the indexed contents 204 which are indexed the user search engine 203. Such definitions of the search results may be applied to every embodiment of the present invention. The method therefore inherently includes an operation of, through the user search engine 203, obtaining “local search results” from the indexed contents 204 stored on the user terminal 10 or any computer terminal connected to the user terminal 10 through any network. The local search results should be returned to the first internet browser through the internet. Those search results from the internet search engine 41 may therefore be distinguished by “internet search results”. Certainly, both the internet search results and the local search results may be ranked according to the bookmark-oriented information.

Please refer to FIG. 6B, which is very similar to FIG. 6A. The only difference is that the bookmark-oriented ranker 202 are installed as software plug-ins or additional source codes compatible and incorporated with the user search engine 203. This embodiment provides a solution to achieve a bookmark-oriented “local search” through the user search engine 203.

Refer to FIG. 6C, which is an explanatory diagram illustrating the operations performed in the method of the embodiment in FIG. 6B. In FIG. 6B, only a local search executed on the user terminal 10 is described.

Operation C-1: Retrieve the search query through the user search engine on the user terminal. That is, the user inputs the search query into a user interface (such as Google Desktop toolbar or sidebar) of the user search engine 203 on the user terminal 10.

Operation C-2: According to the search query, obtain search results from the index contents. The user search engine 203 does not search for actual computer files when receives a search query; instead, the user search engine 203 searches from those indexed contents 204 according to the search query. These indexed contents 204 are indexed before the search query and stored in the user terminal 10. The indexed contents 204 includes at least partial or whole information of a user's e-mails, computer files, viewed/stored webpages, music, photos and chats stored on the user terminal 10 (or on any accessible terminals connected with the user terminal 10 via any type of network). And, a (local) search result here may include a brief of the indexed content 204 and a link (shortcut) addressing the indexed contents 204 stored in the user terminal 10 (and/or any other accessible computer terminal connected thereto through any type of network).

Operation C-3: Rank the (local) search results in accordance with a default ranking algorithm. The default ranking algorithm here is defined by the software developer (such as Google) of desktop search (search on the user terminal and/or those connected thereto) and automatically performed by the user search engine 203, and is changeable by the user in some circumstances. The default ranking algorithm will base on the search query to rank the search results.

Operation C-4: According to bookmark-oriented information: (a) Sort out and rank only the bookmark-oriented search results; or (b) Rank the bookmark-oriented search results prior to the non-bookmark-oriented search results. Operation C-4(a) and (b) both execute the operation of ranking the search results according the bookmark-oriented information; only the details are different. The bookmark-oriented information here has the definition as mentioned above. A bookmark-oriented search result is a search result that indicates an indexed content matching the search query and also a part of the bookmark-oriented information or the whole bookmark-oriented information. A non-bookmark-oriented search result is a search result that indicates an indexed content matching the search query but failing to match any of the bookmark-oriented information.

The bookmark-oriented information needs to be retrieved first so as to be used to rank the search results. That means an operation of retrieving the bookmark-oriented information is inherent here. The bookmark-oriented information may be retrieved by the bookmark-oriented Information extractor 201 installed in the user terminal 10. According to FIG. 6A and 6B, the bookmark-oriented Information extractor 201 may be compatible and incorporated with either the internet browser 20 or the user search engine 203.

Here the bookmark-oriented ranker 202 is also required to rank the search results according to the retrieved bookmark-oriented information. Both the bookmark-oriented Information extractor 201 and the bookmark-oriented ranker 202 are software plug-ins or additional source codes compatible and incorporated with either the internet browser 20 or the user search engine 203. Most importantly, both the bookmark-oriented Information extractor 201 and the bookmark-oriented ranker 202 may be controlled by the user search engine 203. Namely, all the operations of retrieving the bookmark-oriented information and ranking the search results are executed on the internet browser 21. An integrated software plug-in or additional source code package may be provided to incorporate the functions of both the bookmark-oriented Information extractor 201 and the bookmark-oriented ranker 202. Therefore, the bookmark-oriented Information extractor 201 and the bookmark-oriented ranker 202 may be installed as an integrated software plug-in or two independent software plug-in.

In Operation C-4(a), similar to Operation B-5(a) of FIG. 5B and Operation A-3(a) of FIG. 4B, based on the bookmark-oriented information, the bookmark-oriented search results are sorted out first. And then only the sorted-out bookmark-oriented search results are ranked according to the bookmark-oriented information, namely through the bookmark-oriented ranking algorithm.

Operation C-4(b) is similar to Operation C-4(a), Operation B-5(b) of FIG. 5B and Operation A-3(b) of FIG. 4B. However, in Operation B-5(b), the bookmark-oriented search results are sorted out and ranked prior to the non-bookmark-oriented search results. That means both the bookmark-oriented search results and the non-bookmark-oriented search results will be listed on the browser interface of the internet browser 20. If an integration algorithm is defined to incorporate the bookmark-oriented ranking algorithm and the default ranking algorithm, it is possible to provide a mixed-up bookmark-oriented/non-bookmark-oriented search results based on the calculations and weightings of both bookmark-oriented factors and non-bookmark-oriented factors.

All the operations or steps mentioned in the present invention are described in a certain sequence preferable for explanation purpose. The sequence of the operations or steps should be free to rearrange and not be limited to what disclosed in the drawings and the embodiments.

Additional advantages and modifications will readily occur to those proficient in the relevant fields. The invention in its broader aspects is therefore not limited to the specific details and representative embodiments shown and described herein. Accordingly, various modifications may be made without departing from the spirit or scope of the general inventive concept as defined by the appended claims and their equivalents.

What is claimed is:

1. A method of searching and ranking available information, the method being applied to a user terminal and comprising the steps of:
retrieving a search query from a user terminal;
retrieving bookmark-oriented information that is related to at least one bookmark defined through a first internet browser installed in the user terminal; obtaining a plurality of search results according to the search query; and ranking the search results according to the bookmark-oriented information.

2. The method as claimed in claim 1, wherein the bookmark-oriented information is retrieved by a bookmark-oriented information extractor, and the bookmark-oriented information extractor is installed as software plug-in or additional source codes compatible and incorporated with the first internet browser, a user search engine installed on the user terminal, or an internet search engine installed in an internet search server.

3. The method as claimed in claim 1, wherein a bookmark-oriented information uploading interface is provided to upload the bookmark or the bookmark-oriented information through the first internet browser to an internet search engine.

4. The method as claimed in claim 1, wherein at least part of the bookmark-oriented information is used as a text keyword to search within cached webpages stored in an internet cache database or within actual webpages from the internet, or to search within computer files stored in the user terminal and any computer terminal linked to the user terminal, or at least part of the bookmark-oriented information is used as an internet shortcut of a bookmarked webpage or as a file shortcut of bookmarked computer file to search for the search query therein.

5. The method as claimed in claim 1, wherein the search results are ranked by a bookmark-oriented ranker, and the bookmark-oriented ranker is installed as software plug-in or additional source codes compatible and incorporated with the first internet browser, an internet search engine installed in an internet search server, or a user search engine installed on the user terminal.

6. The method as claimed in claim 1, wherein the search results are ranked through a bookmark-oriented ranking algorithm that arranges and incorporates the bookmark-oriented information in an optimized way.

7. The method as claimed in claim 1 further comprising a step of ranking the search results according to a default ranking algorithm, the default ranking algorithm being performed by an internet search engine installed on an internet search server or by a user search engine installed in the user terminal.

8. The method as claimed in claim 1, wherein:
through the internet an internet search engine installed in an internet search server retrieving the search query from the first internet browser of the user terminal;
retrieving the bookmark-oriented information through the internet search engine or the first internet browser;
the internet search engine obtaining the search results from cached webpages stored in an internet cache database; and
the internet search engine ranking the search results according to the bookmark-oriented information.

9. The method as claimed in claim 1, wherein:
an internet search engine of an internet search server retrieving the search query from the first internet browser;
the first internet browser retrieving the bookmark-oriented information;
the internet search engine obtaining the search results from cached webpages stored in an internet cache database according to the search query, and returning the search results to the first internet browser through the internet; and
the first internet browser ranking the search results according to the bookmark-oriented information.

10. The method as claimed in claim 1, wherein:
the first internet browser retrieving the bookmark-oriented information;
an internet search engine of an internet search server retrieving the search query from the first internet browser, and obtaining a plurality of internet search results from cached webpages stored in an internet cache database according to the search query, and returning the internet search results to the first internet browser through the internet;
a user search engine installed in the user terminal obtaining a plurality of local search results from indexed contents stored on the user terminal or any computer terminal connected to the user terminal through any network, and returning the local search results to the first internet browser; and
the first internet browser ranking the internet search results and the local search results according to the bookmark-oriented information.

11. The method as claimed in claim 1, wherein:
a user search engine installed in the user terminal retrieving the bookmark-oriented information;
the user search engine obtaining a plurality of local search results from indexed contents stored on the user terminal or any computer terminal connected to the user terminal through any network; and
the user search engine ranking the local search results according to the bookmark-oriented information.

12. The method as claimed in claim 1, wherein only bookmark-oriented search results are provide and ranked according to the bookmark-oriented information, and each of the bookmark-oriented search results indicates an indexed content or a webpage matching the search query and also at least a part of the bookmark-oriented information.

13. The method as claimed in claim 1, wherein according to the bookmark-oriented information, bookmark-oriented search results are ranked prior to non-bookmark-oriented search results, wherein the bookmark-oriented search results indicates an indexed content or a webpage matching the search query and also at least a part of the bookmark-oriented information, and each of the non-bookmark-oriented search result indicates another indexed content or webpage matching the search query but failing to match any of the bookmark-oriented information.

14. The method as claimed in claim 1, wherein each of the search results comprises at least a brief and at least a link for part or any incorporation of at least one cached webpage stored in an internet cache database, actual webpage from the internet, indexed content stored in the user terminal or any other accessible computer terminal connected to the user terminal through any type of network

15. The method as claimed in claim 1, wherein the bookmark-oriented information comprises at least part, any one or any incorporation of web address or file address, type, description, location, size, date information including setup date, access date, edit date and last review date, folder-related information, and user-defined bookmark-ranking information related to the bookmark.

16. The method as claimed in claim 1, wherein the bookmark comprises a computer-accessible internet shortcut that directs to a certain web address of a specific webpage, and/or a file shortcut addressing a specific computer file stored in the user terminal or any computer terminal connected to the user terminal through any network.

17. The method as claimed in claim 1, wherein the bookmark is selected from one or any incorporation of the group consisting of a terminal bookmark stored in the user terminal or any other computer terminal connected to the user terminal through any type of network, an online bookmark stored on an remote web server, an exported bookmark listed within an exported bookmarking webpage and a second bookmark defined through a second internet browser.

18. A user terminal of searching and ranking available information, comprising:
a first internet browser installed in the user terminal; and
at least one bookmark defined through the first internet browser;
wherein the user terminal is adapted such that the first internet browser retrieves bookmark-oriented information related to the bookmark;
wherein the user terminal is adapted such that the first internet browser, if receives a plurality of search results according to a search query, ranks the search results according to the bookmark-oriented information.

19. The user terminal as claimed in claim 18, wherein the bookmark-oriented information is retrieved by a bookmark-oriented information extractor installed on the user terminal, and the bookmark-oriented information extractor is software plug-in or additional source codes compatible and incorporated with the first internet browser or a user search engine installed on the user terminal.

20. The user terminal as claimed in claim 18, wherein a bookmark-oriented information uploading interface is provided to upload the bookmark or the bookmark-oriented information through the first internet browser to an internet search engine.

21. The user terminal as claimed in claim 18, wherein at least part of the bookmark-oriented information is used as a text keyword to search within cached webpages stored in an internet cache database or within actual webpages from the internet, or to search within computer files stored in the user terminal and any computer terminal linked to the user terminal, or at least part of the bookmark-oriented information is used as an internet shortcut of a bookmarked webpage or as a file shortcut of bookmarked computer file to search for the search query therein.

22. The user terminal as claimed in claim 18, wherein the search results are ranked by a bookmark-oriented ranker installed in the user terminal, and the bookmark-oriented ranker is software plug-in or additional source codes compatible and incorporated with the first internet browser or a user search engine installed on the user terminal.

23. The user terminal as claimed in claim 18, wherein the search results are ranked through a bookmark-oriented ranking algorithm that arranges and incorporates the bookmark-oriented information in an optimized way.

24. The user terminal as claimed in claim 18, wherein the search results is also ranked according to a default ranking algorithm, the default ranking algorithm being performed by an internet search engine installed on an internet search server or by a user search engine installed in the user terminal.

25. The user terminal as claimed in claim 18, wherein only bookmark-oriented search results are provide and ranked according to the bookmark-oriented information, and each of the bookmark-oriented search results indicates an indexed content or a webpage matching the search query and also at least a part of the bookmark-oriented information.

26. The user terminal as claimed in claim 18, wherein according to the bookmark-oriented information, bookmark-oriented search results are ranked prior to non-bookmark-oriented search results, wherein the bookmark-oriented search results indicates an indexed content or a webpage matching the search query and also at least a part of the bookmark-oriented information, and each of the non-bookmark-oriented search result indicates another indexed content or webpage matching the search query but failing to match any of the bookmark-oriented information.

27. The user terminal as claimed in claim 18, wherein each of the search results comprises at least a brief and at least a link for one or any incorporation of at least one cached webpage stored in an internet cache database, actual webpage from the internet, indexed content stored in the user terminal or any other accessible computer terminal connected to the user terminal through any type of network

28. The user terminal as claimed in claim 18, wherein the bookmark is selected from one or any incorporation of the group consisting of a terminal bookmark stored in the user terminal or any other computer terminal connected to the user terminal through any type of network, an online bookmark stored on an remote web server, an exported bookmark listed within an exported bookmarking webpage and a second bookmark defined through a second internet browser installed in the user terminal.

29. An internet search server of searching and ranking available information, the internet search server being connected to the internet and an internet cache database, and through the internet, the internet search server receiving a search query submitted from a first internet browser installed in a user terminal, the internet search server comprising:
an internet search engine, installed in the internet search server and according to the search query, retrieving a plurality of search results from cached webpages stored in the internet cache database;
wherein the internet search server is adapted such that through the internet and the first internet browser, the internet search engine receives bookmark-oriented information related to a bookmark defined through the first internet browser;
wherein the internet search server is adapted such that the internet search engine, if receives the bookmark-oriented information and the search results, ranks the search results according to the bookmark-oriented information and then returns the ranked search results to the first internet browser.

30. The internet search server as claimed in claim 29, wherein the bookmark-oriented information is retrieved by a bookmark-oriented information extractor, and the bookmark-oriented information extractor is installed software plug-in or additional source codes compatible and incorporated with the internet search engine or the first internet browser.

31. The internet search server as claimed in claim 29, wherein a bookmark-oriented information uploading interface is provided to upload the bookmark or the bookmark-oriented information through the first internet browser to the internet search engine.

32. The internet search server as claimed in claim 29, wherein at least part of the bookmark-oriented information is used as a text keyword to search within cached webpages stored in an internet cache database or within actual webpages from the internet, or to search within computer files stored in the user terminal and any computer terminal linked to the user terminal, or at least part of the bookmark-oriented information is used as an internet shortcut of a bookmarked webpage or as a file shortcut of bookmarked computer file to search for the search query therein.

33. The internet search server as claimed in claim 29, wherein the search results are ranked by a bookmark-oriented ranker, and the bookmark-oriented ranker is installed as software plug-in or additional source codes compatible and incorporated with the first internet browser or the internet search engine.

34. The internet search server as claimed in claim 29, wherein the search results are ranked through a bookmark-oriented ranking algorithm that arranges and incorporates the bookmark-oriented information in an optimized way.

35. The internet search server as claimed in claim 29, wherein the internet search engine also ranks the search results according to a default ranking algorithm, the default ranking algorithm being performed by an internet search engine installed on an internet search server or by a user search engine installed in the user terminal.

36. The internet search server as claimed in claim 29, wherein only bookmark-oriented search results are provide and ranked according to the bookmark-oriented information, and each of the bookmark-oriented search results indicates an indexed content or a webpage matching the search query and also at least a part of the bookmark-oriented information.

37. The internet search server as claimed in claim 29, wherein according to the bookmark-oriented information, bookmark-oriented search results are ranked prior to non-bookmark-oriented search results, wherein the bookmark-oriented search results indicates an indexed content or a webpage matching the search query and also at least a part of the bookmark-oriented information, and each of the non-bookmark-oriented search result indicates another indexed content or webpage matching the search query but failing to match any of the bookmark-oriented information.

38. The internet search server as claimed in claim 29, wherein each of the search results comprises at least a brief and at least a link for part or any incorporation of at least one cached webpage stored in an internet cache database, actual webpage from the internet, indexed content stored in the user terminal or any other accessible computer terminal connected to the user terminal through any type of network

39. The internet search server as claimed in claim 29, wherein the bookmark is selected from one or any incorporation of the group consisting of a terminal bookmark stored in the user terminal or any other computer terminal connected to the user terminal through any type of network, an online bookmark stored on an remote web server, an exported bookmark listed within an exported bookmarking webpage and a second bookmark defined through a second internet browser installed in the user terminal.
